(19) United States
(12) Patent Application Publication
(10) Pub. No.: US 2005/0029758 A1
(43) Pub. Date: Feb. 10, 2005

(54) Snow sled

(76) Inventor: Robert D. Ohler, Clare, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/635,595

(22) Filed: Aug. 6, 2003

(51) Int. Cl. B62B 15/00

(52) U.S. Cl. 280/18.1

(57) ABSTRACT

A sled having a bottom 22, 122 surface with a pair of front runners 32, 132 curving toward one another from the front end 12, 112 and into parallel sections directed into two pair of rear runners 34, 36, 134 or 136. The first and second pairs of rear runners 34, 36, 134 and 136 have runners of each pair disposed on opposite sides of a longitudinal axis (A) and both pairs 34, 36, 134 and 136 are disposed closer to the longitudinal axis (A) than the parallel sections of the front runners 32, 132.

### BACKGROUND OF THE INVENTION

1. Field of the Invention

The subject invention relates to a sled having a unique combination of runner relationships for gliding or sledding over snow, or the like.

2. Description of the Related Art

The art is replete with sleds having various combinations or arrangements of runners on the bottom surface of a sled body. Examples of such prior art sleds are shown in U.S. Design Patents Des. 201,815 to Greenberg and Des. 231,516 to Johnson. In addition, U.S. Pat. Nos. 2,139,513 to Nelson et al, 4,561,664 to Cashmere and 5,868,405 to Lavecchia et al disclose various combinations of runners for guiding the sled or toboggan through the snow. It is customary to include arcuate or curved runners for turning and straight runners for stability. However, in such prior art runner placements, the arcuate runners are longitudinally co-extensive with the straight runners and/or at least one of the arcuate or straight runners extend substantially the entire length of the bottom of the sled or toboggan.

### BRIEF SUMMARY OF THE INVENTION AND ADVANTAGES

The subject invention provides a unique combination of runner placements on a body having front and rear ends, sides and top and bottom surfaces and an axis extending longitudinally from the front end to the rear end to divide the body into two longitudinal symmetrical halves. A pair of front runners extends arcuately in the longitudinal direction along the bottom surface from the front end toward the longitudinal middle of the body and is disposed on opposite sides of the axis. At least one rear runner extends longitudinally straight along the bottom surface from the rear end toward the middle of the body. The arrangement is distinguished by a major portion of the extent of the front runners being devoid of longitudinal overlap with the rear runner and a major portion of the extent of the rear runner being devoid of longitudinal overlap with the front runners whereby the front runners lead into the rear runners adjacent the middle of the body.

Accordingly, the sled of the subject invention substantially separates the arcuate front runners longitudinally form the straight rear runners to provide very responsive control during sledding, the control often producing exciting movements, such as shifting movements.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a bottom view of a first embodiment of the invention;

FIG. 2 is rear view taken along line 2-2 of FIG. 1;

FIG. 3 is front view taken along line 3-3 of FIG. 1;

FIG. 4 is a bottom view of a second embodiment of the invention; and

FIG. 5 is a side view taken along line 5-5 of FIG. 4.

### DETAILED DESCRIPTION OF THE INVENTION

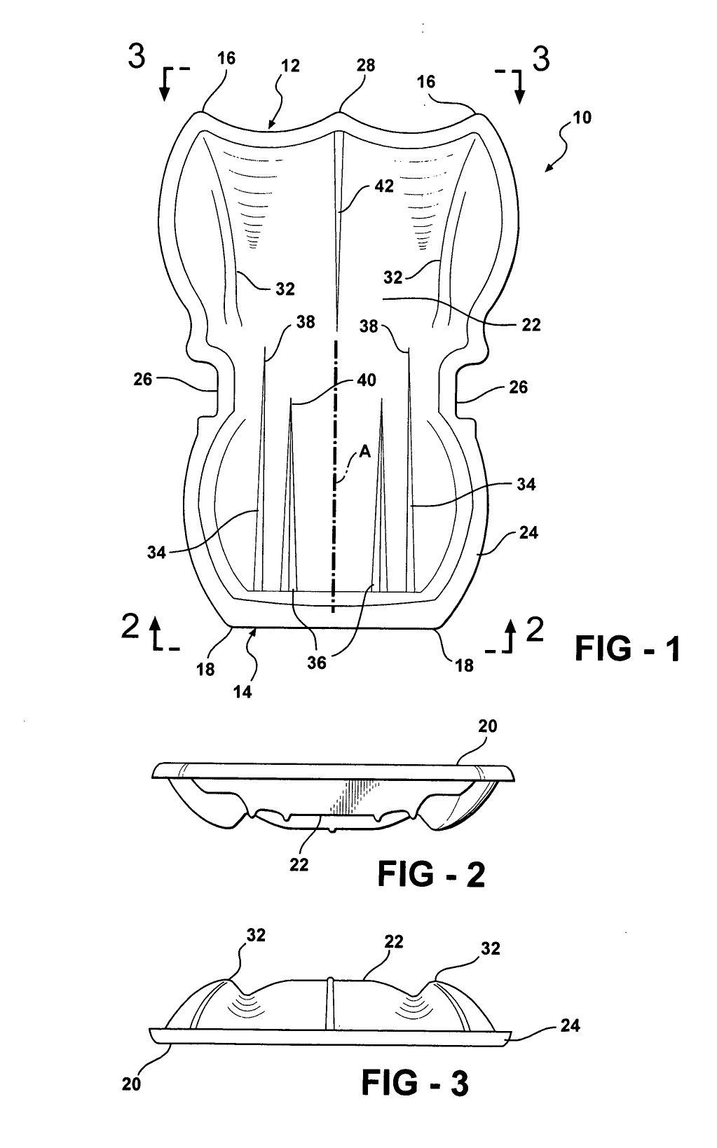

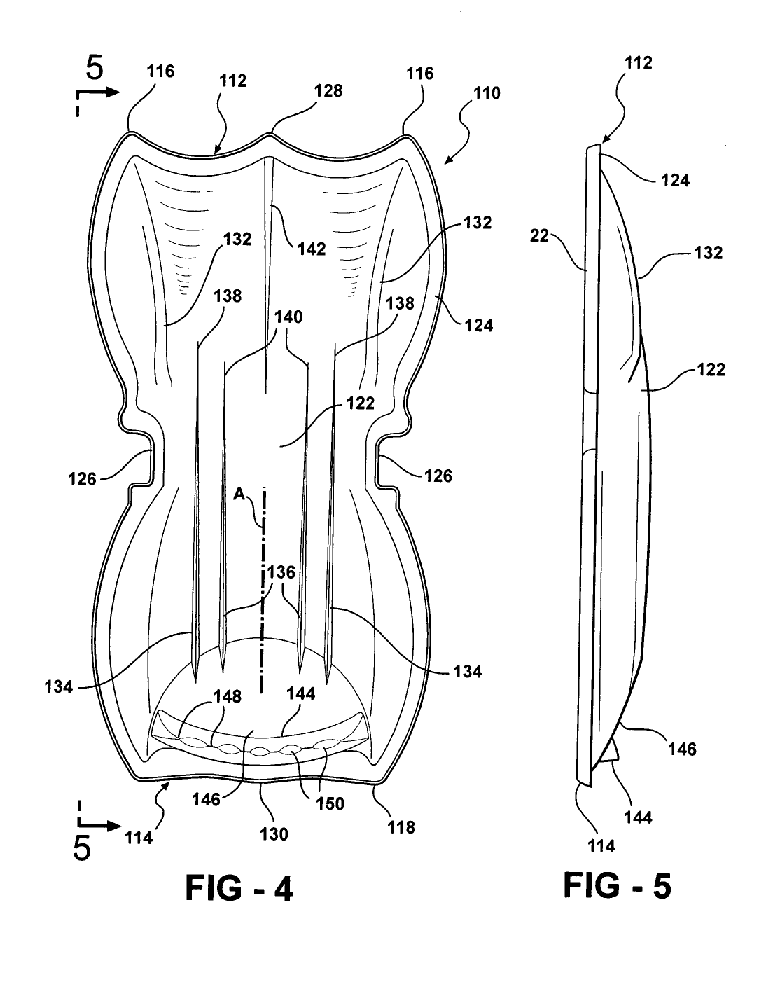

Referring to the Figures, wherein two embodiments of the sled are shown, a first generally at 10 in FIGS. 1-3 and the second generally at 110 in FIGS. 4 and 5, with like numerals separated by one hundred indicating like or corresponding parts throughout the embodiments.

The sled 10, 110 comprises an integral body molded in one piece of a single sheet of plastic material and having various features which are described below and shown in the drawings, all of which are formed in the sheet material by a process such as thermo-forming, and are all non-moving relative to the body (i.e., none of the features articulate or more relative to the sheet). The sled 10, 110 has a front end 12, 112 and a rear end 14, 114 interconnected by sides at front corners 16, 116 and rear corners 18, 118. The sled 10, 110 includes top 20, 120 and bottom 22, 122 surfaces and an axis (A) extending longitudinally from the front end 12, 112 to the rear end 14, 114 dividing the body into two longitudinal symmetrical halves. The center of the body extends downwardly or is concave and is surrounded by a peripheral laterally extending flange 24, 124 that is waisted in the middle between the two front corners 16, 116 and the two rear corners 18, 118. The waisted middle includes or is defined by a pair of notches 26, 126 in the flange 24, 124 on either side of the middle. The flange 24, 124 bulges outwardly between the notches 26, 126 and the front 16, 116 and rear corners 18, 118 to define an hourglass-like shape, although the bulge adjacent the front corners 16 of the first embodiment is wider than the bulge adjacent the rear corners 18. The flange 24, 124 also includes a lead point 28, 128 on the center axis (A) at the front end 12, 112 between the front corners 16, 116. In the first embodiment, the flange 24 is straight across between the rear corners 18 whereas in the second embodiment the flange 124 includes a trailing point 130 on the center axis (A) at the rear end 114 between the rear corners 118.

A pair of front runners 32, 132 extend arcuately in the longitudinal direction along the bottom surface 22, 122 from the front end 12, 112 toward the longitudinal middle of the body and are disposed on opposite sides of the axis (A), i.e., the pair of runner 32, 132 straddle the longitudinal axis (A). The front runners 32, 132 curve toward one another from the front end 12, 112 toward the middle.

A plurality of rear runners comprising first 34, 134 and second 36, 136 pairs extend longitudinally straight along the bottom surface 22, 122 from the rear end 14, 114 toward the middle of the body. The front runners 32, 132 curve toward one another from the front end 12, 112 and into parallel rear sections directed into the rear runners 34, 134, 36 and 136. More specifically, a major portion of the extent of the front runners 32, 132 are devoid of longitudinal overlap with the rear runners 34, 134, 36 and 136 and a major portion of the extent of the rear runners 34, 134, 36 and 136 are devoid of longitudinal overlap with the front runners 32, 132 whereby the front runners 32, 132 lead into the rear runners 34, 134, 36 and 136 adjacent the middle of the body. In fact, the front runners 32 in the first embodiment do not overlap the rear runners 34 or 36 in the first embodiment whereas less than twenty percent (20%) of the length of the front 132 and rear 134 or 136 runners of the second embodiment overlap.

The plurality of rear runners 34, 36, 134 and 136 are disposed closer to the longitudinal axis (A) than the front runners 32, 132. In other words, the runners of each of the first and second pairs of rear runners 34, 36, 134 and 136 are disposed on opposite sides of the longitudinal axis (A) and both pairs are disposed closer to the longitudinal axis (A) than the parallel rear sections of the front runners 32, 132 with the second pair 36, 136 of rear runners disposed inside the first pair 34, 134 of rear runners, which are, in turn, disposed inside the parallel sections of said front runners 32, 132,. The first and second pairs of rear runners 34, 36, 134 and 136 each have a front end and the front ends 38, 138 of the first pair of rear runners 34, 134 being closer to the front end 12, 112 of the body than the front ends 40, 140 of the second pair of rear runners 36, 136. In order to improve directional control, each of the rear runners 34, 36, 134 and 136 tapers from a point at the front end 38, 40, 138 and 140 thereof adjacent the middle to a wide section adjacent the rear end 14, 114 of the body.

The sled includes at least one straight guide runner 42, 142 disposed on the longitudinal axis (A) and on the bottom surface 22, 122 between the front runners 32, 132. The guide runner 42, 142 is substantially co-extensive longitudinally with the front runners 32, 132 and tapers in a narrowing fashion from the front end 12, 112 toward the middle of the body.

As illustrated in the second embodiment of FIGS. 4 and 5, the sled may include a brake ridge 144 disposed in an arcuate path across the longitudinal axis (A) adjacent the rear end 114 of the body. So that the brake ridge is not in the braking mode during normal sledding, the rear runners 34, 36, 134 and 136 extend outwardly from the bottom surface 122 of the body further than the brake ridge 144. To facilitate this, the body includes an inclined section 146 adjacent the rear end 114 and slanting upwardly into the body from the wide end of the rear runners 34, 36, 134 and 136 to the rear end 14, 114 of the body with the brake ridge 144 disposed on and extending upwardly from the inclined section 146. The brake ridge 144 comprises a plurality of teeth 148 separated by a plurality of interleaved arches 150.

Obviously, many modifications and variations of the present invention are possible in light of the above teachings. The invention may be practiced otherwise than as specifically described within the scope of the appended claims.

1. A sled comprising:
a body having front and rear ends and sides and top and bottom surfaces and an axis (A) extending longitudinally from said front end to said rear end dividing said body into two longitudinal symmetrical halves, and
a pair of front runners extending arcuately in the longitudinal direction along said bottom surface from said front end toward the longitudinal middle of said body and disposed on opposite sides of said axis (A),
at least one rear runner extending longitudinally straight along said bottom surface from said rear end toward said middle of said body, and
a major portion of the extent of said front runners being devoid of longitudinal overlap with said rear runner and a major portion of the extent of said rear runner being devoid of longitudinal overlap with said front runners whereby said front runners lead into said rear runners adjacent the middle of said body.

2. A sled as set forth in claim 1 wherein said front runners curve toward one another from said front end toward said middle.

3. A sled as set forth in claim 1 wherein said front runners curve toward one another from said front end and into parallel sections directed into said rear runner.

4. A sled as set forth in claim 2 including a plurality of said rear runners.

5. A sled as set forth in claim 4 wherein said plurality of rear runners are disposed closer to said longitudinal axis (A) than said front runners.

6. A sled as set forth in claim 2 including a first pair of said rear runners disposed on opposite sides of said longitudinal axis (A).

7. A sled as set forth in claim 6 wherein each of said rear runners tapers from a point adjacent said middle to a wide section adjacent said rear end.

8. A sled as set forth in claim 6 including a second pair of rear runners disposed on opposite sides of said longitudinal axis (A) and inside said first pair of rear runners.

9. A sled as set forth in claim 3 including first and second pairs of rear runners with runners of each pair disposed on opposite sides of said longitudinal axis (A) and both pairs disposed closer to said longitudinal axis (A) than said parallel sections of said front runners.

10. A sled as set forth in claim 3 including first and second pairs of rear runners with said second pair of rear runners being disposed inside said first pair of rear runners and said first pair of rear runners being disposed inside said parallel sections of said front runners said first and second pairs of runners each having a front end, said front ends of said first pair of rear runners being closer to said front end of said body than said front ends of said second pair of rear runners.

11. A sled as set forth in claim 10 wherein each of said rear runners tapers from said front end thereof to a wide section adjacent said rear end.

12. A sled as set forth in claim 11 including at least one straight guide runner disposed on said bottom surface between said front runners.

13. A sled as set forth in claim 12 wherein said guide runner is straight and disposed on said longitudinal axis (A).

14. A sled as set forth in claim 13 wherein guide runner is substantially co-extensive longitudinally with said front runners.

15. A sled as set forth in claim 13 wherein said guide runner tapers in a narrowing fashion from said front end toward said middle of said body.

16. A sled as set forth in claim 1 including a brake ridge disposed in an arcuate path across said longitudinal axis (A) adjacent said rear end of said body.

17. A sled as set forth in claim 17 wherein said rear runner extends outwardly from said body further than said brake ridge.

18. A sled as set forth in claim 17 wherein said brake ridge comprises a plurality of teeth separated by a plurality of interleaved arches.

19. A sled as set forth in claim 17 wherein said body includes an inclined section adjacent said rear end and slanting upwardly into said body from said rear runner to said rear end of said body, said brake ridge being disposed on and extending upwardly from said inclined section.

20. A sled as set forth in claim 1 wherein said body includes a downwardly extending center surrounded by a peripheral flange.

21. A sled as set forth in claim 20 wherein said pheriphal flange includes two front corners and two rear corners and a waisted middle.

22. A sled as set forth in claim 21 wherein said waisted middle includes a pair of notches in said flange on either side of said middle.

23. A sled as set forth in claim 22 wherein said flange bulges outwardly between said notches and said front and rear corners to define an hourglass-like shape.

24. A sled as set forth in claim 23 wherein said flange includes a lead point on said center axis (A) at said front end between said front corners.

25. A sled as set forth in claim 23 wherein said flange includes a trailing point on said center axis (A) at said rear end between said rear corners.

26. A sled as set forth in claim 23 wherein said flange is straight across between said rear corners.

27. A sled as set forth in claim 1 wherein said body is fabricated of a single sheet of plastic material.

28. A sled as set forth in claim 28 wherein said single sheet of plastic material includes a braking ridge adjacent to said rear end of said body.
